(19) United States
(12) Patent Application Publication
(10) Pub. No.: US 2015/0084944 A1
(43) Pub. Date: Mar. 26, 2015

(54) DISPLAY DEVICE AND DRIVING METHOD THEREOF

(71) Applicant: SAMSUNG DISPLAY CO., LTD., Yongin-City (KR)

(72) Inventors: SUN-KOO KANG, Seoul (KR); WON TAE KIM, Cheongju-si (KR); YOUNG-IL BAN, Seoul (KR); SUN KYU SON, Suwon-si (KR)

(73) Assignee: SAMSUNG DISPLAY CO., LTD., Yongin-City (KR)

(21) Appl. No.: 14/180,584

(22) Filed: Feb. 14, 2014

(30) Foreign Application Priority Data
Sep. 23, 2013 (KR) 10-2013-0112779

(51) Int. Cl. G09G 3/36

(52) U.S. Cl. CPC G09G 3/3696; G09G 3/3607; G09G 2310/0289; G09G 2310/0235
USPC 345/212; 345/84

(57) ABSTRACT

A display device includes a display panel and a driving voltage generator. The driving voltage generator generates a first quarter power voltage and a second quarter power voltage. The first quarter power voltage has a level between a power voltage and a half power voltage. The second quarter power voltage has a level between the half power voltage and a ground voltage. A data driver alternately outputs the first quarter power voltage or the second quarter power voltage and a data voltage to the data line. A signal controller controls the driving voltage generator and the data driver. The signal controller includes a pattern recognition unit determining an image pattern of an image based on an input image signal. The signal controller controls the driving voltage generator to adjust the levels of the first quarter power voltage and the second quarter power voltage, based on the determined image pattern.

### CROSS-REFERENCE TO RELATED APPLICATION

This application claims priority to and the benefit of Korean Patent Application No. 10-2013-0112779 filed in the Korean Intellectual Property Office on Sep. 23, 2013, the disclosure of which is incorporated by reference herein in its entirety.

### TECHNICAL FIELD

Exemplary embodiments of the present invention relate to displays, and more particularly, to a display device and a driving method thereof.

### DISCUSSION OF THE RELATED ART

A display such as a liquid crystal display (LCD) or an organic light emitting diode display includes a display panel having a plurality of pixels and a plurality of signal lines and a driver for driving the display panel.

As the size and resolution of the display device increase, more heat may be generated from the data driver of the display device.

### SUMMARY

According to an exemplary embodiment of the present invention, a display device includes a display panel. The display panel includes a data line. A driving voltage generator generates a first quarter power voltage (QHAVDD) and a second quarter power voltage (QLAVDD). The first quarter power voltage has a level between a power voltage (AVDD) and a half power voltage (HAVDD). The second quarter power voltage has a level between the half power voltage (HAVDD) and a ground voltage. A data driver alternately outputs the first quarter power voltage or the second quarter power voltage and a data voltage to the data line. A signal controller controls the driving voltage generator and the data driver. The signal controller includes a pattern recognition unit. The pattern recognition unit determines an image pattern of an image based on an input image signal. The signal controller controls the driving voltage generator to adjust the levels of the first quarter power voltage and the second quarter power voltage, based on the determined image pattern.

The pattern recognition unit may determine the image pattern by determining a region that, in the image, represents a grayscale greater than or equal to a predetermined grayscale or smaller than or equal to the predetermined grayscale based on the input image signal.

The signal controller may further include a lookup table storing information on a plurality of levels of the first quarter power voltage and a plurality of levels of the second quarter power voltage depending on the ratio of the region.

As the region that represents the grayscale greater than or equal to the predetermined grayscale in the image, the first quarter power voltage in the lookup table may increase, and the second quarter power voltage in the lookup table may decrease.

The data driver may include a switch switching between the data voltage and the first quarter power voltage or the second quarter power voltage.

The data driver may output the first quarter power voltage or the second quarter power voltage during a first period and may output the data voltage during a second period following the first period.

A sum of the first period and the second period may be substantially the same as one horizontal period.

The data driver may output the first quarter power voltage during the first period when a polarity of the data voltage is positive, and may output the second quarter power voltage during the first period when the polarity of the data voltage is negative.

The data voltage output to one data line may have the same polarity for one frame.

According to an exemplary embodiment of the present invention, a method of driving a display device is provided. The display device includes a display panel. The display panel includes a plurality of pixels and a plurality of data lines. The display device further includes a driving voltage generator, a data driver, and a signal controller. The signal controller controls the driving voltage generator and the data driver. In the method, an image pattern of an image is determined based on an input image signal. A control signal is generated controlling levels of a first quarter power voltage (QHAVDD) and a second quarter power voltage (QLAVDD) based on the determined image pattern. The first quarter power voltage has a level between a power voltage (AVDD) and a half power voltage (HAVDD). The second quarter power voltage has a level between the half power voltage and a ground voltage. The first quarter power voltage and the second quarter power voltage are generated based on the control signal. The first quarter power voltage or the second quarter power voltage and a data voltage are alternately output to the data line.

A region that, in the image, represents a grayscale greater than or equal to a predetermined grayscale or smaller than or equal to the predetermined grayscale may be determined.

The control signal may be generated using a lookup table storing information on a plurality of levels of the first quarter power voltage and a plurality of levels of the second quarter power voltage depending on the region in the image.

As the region that represents the grayscale greater than or equal to the predetermined grayscale in the image, the first quarter power voltage in the lookup table may increase, and the second quarter power voltage in the lookup table may decrease.

The data driver may include a switch switching between the data voltage and the first quarter power voltage or the second quarter power voltage.

The data driver may output the first quarter power voltage or the second quarter power voltage during a first period and may output the data voltage during a second period following the first period.

A sum of the first period and the second period may be substantially the same as one horizontal period.

The data driver may output the first quarter power voltage during the first period when a polarity of the data voltage is positive, and may output the second quarter power voltage during the first period when the polarity of the data voltage is negative.

The data voltage outputting to one data line may have the same polarity for one frame.

According to an exemplary embodiment of the present invention, a display device comprises a display panel. A driving voltage generator is configured to generate a power voltage, a half power voltage, a first quarter power voltage, and a second quarter power voltage. The first quarter power voltage has a level between the power voltage and the half power voltage. The second quarter power voltage has a level between the half power voltage and a ground voltage. A gray voltage generator is configured to generate a data voltage from the power voltage and the half power voltage. A data driver is configured to alternately output the first quarter power voltage or the second quarter power voltage and the data voltage to the display panel. A signal controller is configured to determine an image pattern of an image from an external circuit and is configured to control the driving voltage generator to adjust the levels of the first quarter power voltage and the second quarter power voltage, based on the determined image pattern.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a block diagram of a display device according to an exemplary embodiment of the present invention;

FIG. 2 is a block diagram of a data driver according to an exemplary embodiment of the present invention;

FIG. 3 is a circuit diagram of an output buffer of a data driver according to an exemplary embodiment of the present invention;

FIG. 4 is a circuit diagram of an output buffer of a data driver as shown in FIG. 3, according to an exemplary embodiment of the present invention;

FIGS. 5 and 6 illustrate waveforms of output voltages of a data driver according to an exemplary embodiment of the present invention;

FIG. 7 is a block diagram of a signal controller of a display device according to an exemplary embodiment of the present invention;

FIG. 8 is a circuit diagram of a driving voltage generator of a display device according to an exemplary embodiment of the present invention;

FIG. 9 illustrates waveforms of output voltages of a data driver for several quarter driving voltages;

FIG. 10 is a table showing results obtained by measuring heat generated from a data driver according to quarter driving voltages and image patterns;

FIG. 11 is a graph showing heat generated for different image patterns according to a lookup table of a pattern recognition unit according to an exemplary embodiment of the present invention;

FIG. 12 shows an example of an image pattern displayed by a display device according to an exemplary embodiment of the present invention;

FIG. 13 illustrates waveforms of output voltages output from a data driver for an image pattern shown in FIG. 12, according to an exemplary embodiment of the present invention;

FIG. 14 shows an example of an image pattern displayed by a display device according to an exemplary embodiment of the present invention;

FIG. 15 illustrates waveforms of output voltages output from a data driver for an image pattern shown in FIG. 14, according to an exemplary embodiment of the present invention; and

FIG. 16 is a flowchart showing a method of driving a display device according to an exemplary embodiment of the present invention.

### DETAILED DESCRIPTION OF EMBODIMENTS

Exemplary embodiments of the present invention will be hereinafter described in detail with reference to the accompanying drawings. The present invention, however, may be modified in various different ways, and should not be construed as limited to the embodiments set forth herein. The same denotations may be used to refer to the same or substantially the same elements throughout the specification and the drawings. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

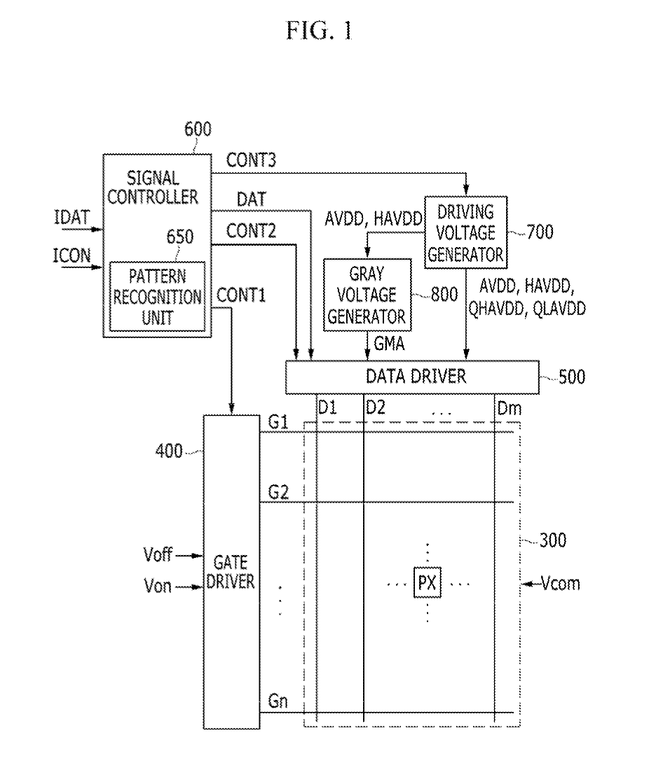

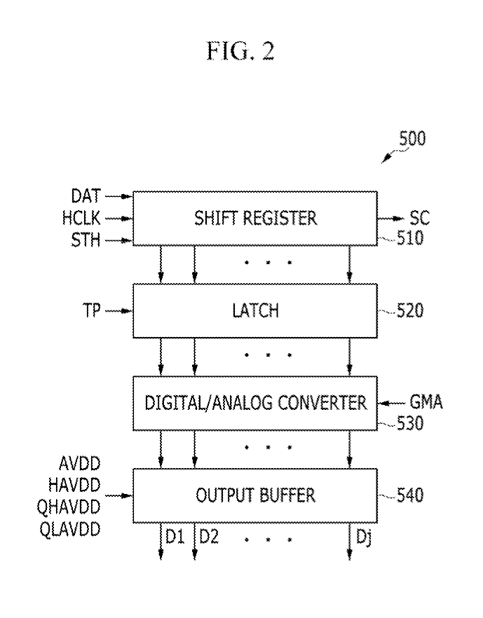

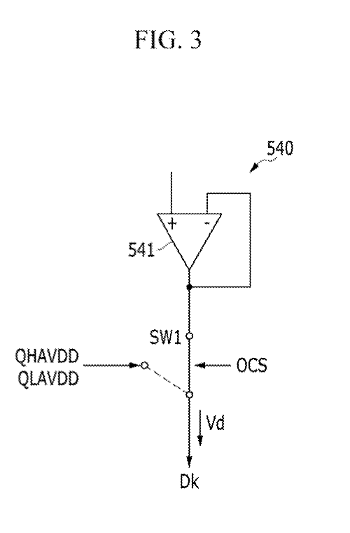

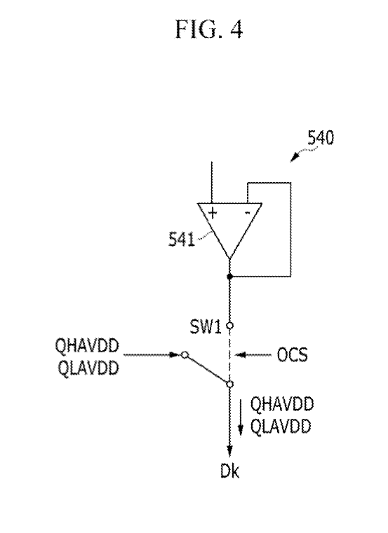

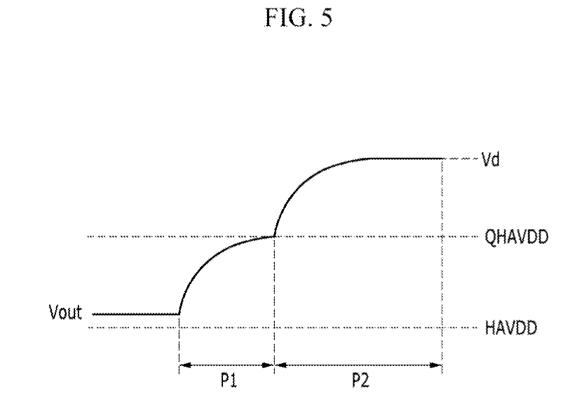

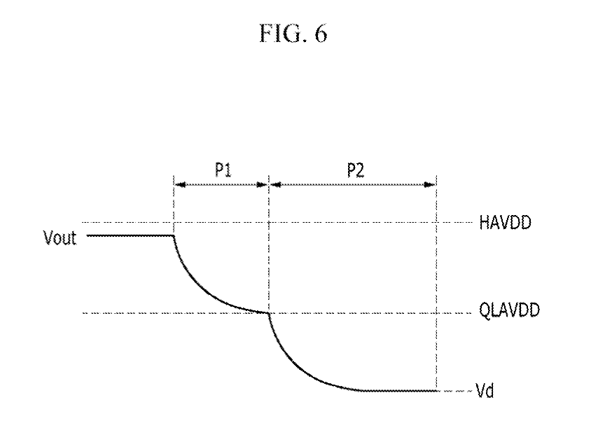

FIG. 1 is a block diagram of a display device according to an exemplary embodiment of the present invention. FIG. 2 is a block diagram of a data driver according to an exemplary embodiment of the present invention. FIG. 3 is a circuit diagram of an output buffer of a data driver according to an exemplary embodiment of the present invention. FIG. 4 is a circuit diagram of a output buffer of a data driver as shown in FIG. 3, according to an exemplary embodiment of the present invention. FIGS. 5 and 6 illustrate waveforms of output voltages of a data driver according to an exemplary embodiment of the present invention.

Referring to FIG. 1, a display device according to an exemplary embodiment of the present invention may include a display panel 300, a gate driver 400 and a data driver 500 connected to the display panel 300, a gray voltage generator 800 connected to the data driver 500, a driving voltage generator 700, and a signal controller 600 controlling the above components.

The display panel 300 includes a plurality of signal lines and a plurality of pixels PX which are connected to the signal lines and arranged in a matrix. When the display device according to an exemplary embodiment of the present invention is a liquid display device, the display panel 300, when viewed from a sectional structure thereof, may include lower and upper display panels (not shown) facing each other and a liquid crystal layer (not shown) interposed therebetween.

The signal lines include a plurality of gate lines G1-Gn for transmitting gate signals (also called “scan signals”) and a plurality of data lines D1-Dm for transmitting data voltages. The gate lines G1-Gn are parallel with each other, and may be extended substantially in a row direction of the display panel 300. The data lines D1-Dm are parallel with each other, and may be extended substantially in a column direction of the display panel 300.

One pixel PX may include at least one switching element connected to at least one of the data lines D1-Dm and at least one of the gate lines G1-Gn, and at least one pixel electrode (not shown) connected to the switching element. The switching element may include a thin film transistor. The switching elements may transmit data voltages from the data lines D1-Dm to the pixel electrodes of the respective pixels PX under the control of the gate signals transmitted from the gate lines G1-Gn.

Each pixel PX displays one of primary colors (spatial division) or alternately displays primary colors according to time (temporal division), and a desired color can be recognized by primary colors displayed in the spatial or temporal division manner. Examples of the primary colors may be red, green, blue, yellow, cyan, magenta, or the like. A plurality of pixels PX respectively displaying different primary colors from each other may form one pixel set (also called a “dot”). One dot may display a white image.

The signal controller 600 receives an input image signal IDAT and an input control signal ICON from, e.g., a graphics controller and controls operations of the gate driver 400, the data driver 500, the driving voltage generator 700, and the gray voltage generator 800.

The input image signal IDAT contains luminance information of each pixel PX. The luminance information has a predetermined number of grayscales, for example, 1024 (=2¹⁰) 256 (=2⁸), or 64 (=2⁶) grayscales. The input image signal IDAT may be provided for each of the primary colors displayed by the pixel PX. Examples of the input control signal ICON may include a vertical synchronization signal, a horizontal synchronization signal, a main clock signal, a data enable signal, and the like.

The signal controller 600 converts the input image signal IDAT into an output image signal DAT based on the input image signal IDAT and the input control signal ICON and generates a gate control signal CONT1, a data control signal CONT2, and a driving voltage control signal CONT3.

The gate control signal CONT1 may include a scanning start signal STV that for indicating a scanning start of the gate signal and at least one gate clock signal that controls an output period of a gate-on voltage Von.

The data control signal CONT2 includes a horizontal synchronization start signal for indicating a transmission start of the output image signal DAT for one row of pixels PX, a data load signal LOAD for applying an analog data voltage to the data lines D1-Dm, a data clock signal HCLK, an output voltage control signal OCS, and the like. The data control signal CONT2 may further include an inverse signal RVS for inverting the polarity of the data voltage with respect to the common voltage Vcom for each frame.

The driving voltage control signal CONT3 may contain information about the level of the driving voltage, for example, the levels of quarter power voltages QHAVDD and QLAVDD. The information about the levels of the quarter power voltages QHAVDD and QLAVDD may be varied according to the image pattern of the input image signal IDAT.

Referring to FIG. 1, the signal controller 600 according to an exemplary embodiment of the present invention may include a pattern recognition unit 650 for determining an image pattern. The pattern recognition unit 650 may determine an image pattern that is included in the image of a frame, based on the input image signal IDAT. For example, the pattern recognition unit 650 may determine whether the image of a frame includes a horizontal stripe pattern or a ratio of a black or white grayscale region in the image to the rest of the image. The black grayscale may be a grayscale smaller than or equal to a predetermined grayscale, and the white grayscale may be a grayscale greater than or equal to a predetermined high grayscale. The signal controller 600 may generate the driving voltage control signal CONT3 for adjusting the levels of quarter power voltages QHAVDD and QLAVDD according to a result determined by the pattern recognition unit 650.

According to an exemplary embodiment of the present invention, the pattern recognition unit 650 may be provided separately from the signal controller 600. In this case, the pattern recognition unit 650 may transmit a result determined on the image pattern to the signal controller 600.

The driving voltage generator 700 generates a plurality of driving voltages in response to the driving voltage control signal CONT3 from the signal controller 600. The plurality of driving voltages include a power voltage AVDD, a half power voltage HAVDD, a high quarter power voltage QHAVDD, and a low quarter power voltage QLAVDD. The level of the half power voltage HAVDD is about half the power voltage AVDD. The high quarter power voltage QHAVDD has a level between the half power voltage HAVDD and the power voltage AVDD. The low quarter power voltage QLAVDD has a level between the ground voltage and the half power voltage HAVDD. For example, the level of the power voltage AVDD may be about 17.4 V, but is not limited thereto. For example, the driving voltage generator 700 may adjust and generate the levels of the quarter power voltages QHAVDD and QLAVDD in response to the control signal CONT3 of the driving voltage from the signal controller 600.

The driving voltage generator 700 sends the power voltage AVDD and the half power voltage HAVDD to the gray voltage generator 800, and sends the power voltage AVDD, the half power voltage HAVDD, the high quarter power voltage QHAVDD, and the low quarter power voltage QLAVDD to the data driver 500.

The gray voltage generator 800 generates all of the gray voltages GMA or a predetermined number of gray voltages (called “reference gray voltages”), which are associated with the transmittance of the pixels PX, by using the power voltage AVDD and the half power voltage HAVDD together with the ground voltage. The gray voltage may include a positive-polarity gray voltage and a negative-polarity gray voltage with respect to the common voltage Vcom. The positive-polarity gray voltage may be higher than the half power voltage HAVDD, and the negative-polarity gray voltage may be lower than the half power voltage HAVDD. The gray voltage generator 800 sends the gray voltages GMA or the reference gray voltages to the data driver 500.

The gate driver 400, which is connected to the gate lines G1-Gn, generates gate signals in response to the gate control signal CONT1 from the signal controller 600 and applies the gate signals to the gate lines G1-Gn. The gate signals include a gate-on voltage Von and a gate-off voltage Voff.

The data driver 500, which is connected to the data lines D1-Dm, selects the gray voltages GMA from the gray voltage generator 800 based on the output image signal DAT received from the signal controller 600, and the data driver 500 applies the selected gray voltages as data voltages to the data lines D1-Dm. However, when the gray voltage generator 800 supply not all the gray voltages GMA, but a predetermined number of reference gray voltages, the data driver 500 divides the reference gray voltages to thus generate gray voltages for all the grayscales.

Referring to FIG. 2, the data driver 500 according to an exemplary embodiment of the present invention may include at least one data driving circuit as shown in FIG. 2. The data driving circuit may include a shift register 510, a latch 520, a digital/analog converter 530, and an output buffer 540.

When the shift register 510 receives a horizontal synchronization start signal STH (or shift clock signal), the shift signal register 510 sequentially shifts the output image signal DAT of each channel, which is input in response to the data clock signal HCLK, and transmits the shifted signal to the latch 520. When the data driver 500 includes a plurality of data driving circuits, the shift register 510 may shift all of the output image signals DAT, which are assigned to the shift register 510, and then may send a shift clock signal SC to a shift register 510 of an adjacent data driving circuit.

The latch 520 sequentially receives and stores the output image signals DAT from the shift register 510 and outputs the output image signals DAT to the digital/analog converter 530 substantially at the same time in response to the data load signal TP.

The digital/analog converter 530 receives gray voltages GMA from the gray voltage generator 800, converts the output image signals DAT into analog data voltages by using the received gray voltages, and then sends the analog data voltages to the output buffer 540. The analog data voltage may have a positive level or a negative level with respect to the common voltage Vcom.

The output buffer 540 receives a plurality of driving voltages from the driving voltage generator 700, and receives the analog data voltages from the digital/analog converter 530. The output buffer 540 alternately applies the quarter power voltage QHAVDD or QLAVDD and the data voltage, as output voltages Vout, to data lines D1-Dj (j≦m).

Referring to FIGS. 3 and 4, the output buffer 540 of the data driver 500 according to an exemplary embodiment of the present invention includes an amplifier 541 and a switch SW1.

The amplifier 541 may receive the analog data voltages from the digital/analog converter 530 to impedance-convert the analog data voltages. The amplifier 541 may receive, as a power source, a power voltage AVDD and a ground voltage, a power voltage AVDD and a half power voltage HAVDD, or a half power voltage HAVDD and a ground voltage. A non-inversion input terminal (+) of the amplifier 541 may receive the analog data voltage Vd from the digital/analog converter 530, and an inversion input terminal (−) of the amplifier 541 is connected to an output terminal to receive the output voltage as a feedback.

An output terminal of the switch SW1 is connected to the data line Dk (k=1, . . . , j), and an input terminal of the switch SW1 may be switched between the output terminal of the amplifier 541 and the input terminal of the quarter power voltage QHAVDD or QLAVDD. The operation of the switch SW1 may be controlled by the output voltage control signal OCS from the signal controller 600. For example, the switch SW1 may be connected to the quarter power voltage QHAVDD or QLAVDD when the output voltage control signal OCS is at a high level, and the switch SW1 may be connected to the output terminal of the amplifier 541 when the output voltage control signal OCS is at a low level.

The switch SW1 may alternately output the quarter power voltage QHAVDD or QLAVDD and the data voltage from the output terminal of the amplifier 541 under the control of the output voltage control signal OCS.

Referring to FIGS. 5 and 6, with respect to the output voltage Vout of the data driver 500 for the pixels PX of each row, a quarter power voltage QHAVDD or QLAVDD is output to the data lines D1-Dj during a first period (P1) before outputting of the data voltage Vd, and then the data voltage Vd is output during a second period (P2). FIG. 5 illustrates an output voltage Vout for a frame in which the data voltage Vd has a positive polarity based on the common voltage Vcom, and FIG. 6 illustrates an output voltage Vout for a frame in which the data voltage Vd has a negative polarity based on the common voltage Vcom.

The first period (P1) may be shorter than the second period (P2), but exemplary embodiments of the present invention are not limited thereto. The first period (P1) and the second period (P2) may be adjusted depending on driving conditions of the data driver 500. The sum of the first period (P1) and the second period (P2) in which the output voltage Vout for a row of pixels PX is output may be substantially the same as one horizontal period (1H).

The polarity of the output voltage Vout that is output from each of the data lines D1-Dm for one frame may be constant. For example, the output voltage Vout output to each of the data lines D1-Dm for one frame may have a higher level than the half power voltage HAVDD. Therefore, heat generated from the data driver 500 can be reduced as compared with a driving method by which the polarity of the output voltages output to the respective data lines D1-Dm for one frame is inverted for every row.

Further, in an exemplary embodiment of the present invention, the data driver 500 outputs the quarter power voltage QHAVDD or QLAVDD input from the driving voltage generator 700 before outputting the data voltage Vd for each pixel PX, to thus perform a operation as shown in FIG. 5 or 6. Therefore, the data driver 500 consumes power during the second period (P2) in which the data voltage (Vd) is output through the amplifier 541 and might not consume power in other periods, and thus may further reduce the heat generated.

The driver may be implemented in at least one integrated circuit (IC) chip that is mounted directly on a display panel 300. The driver may be mounted on, e.g., a flexible printed circuit film in the form of a tape carrier package (TCP) and may be attached to a display panel 300. The driver may be mounted on a separate printed circuit board. Alternatively, the driver, together with signal lines G1-Gn and D1-Dm, thin film transistors, may be integrated in the display panel 300.

The signal controller 600 receives an input image signal IDAT and an input control signal ICON for controlling the display of the input image signal IDAT, from an external graphics controller (not shown).

The signal controller 600 processes the input image signal IDAT according to operation conditions of the display panel 300, based on the input image signal IDAT and the input control signal ICON and generates a gate control signal CONT1, a data control signal CONT2, and a driving voltage control signal CONT3. The signal controller 600 sends the gate control signal CONT1 to the gate driver 400, sends the data control signal CONT2 and the processed output image signal DAT to the data driver 500, and sends the driving voltage control signal CONT3 to the driving voltage generator 700.

The data driver 500 receives the output image signal DAT for a row of pixels PX in response to the data control signal CONT2 from the signal controller 600, selects gray voltages corresponding to the output image signal DAT, converts the output image signal DAT, which is a digital signal, into analog data voltages Vd, and alternately applies the quarter voltage QHAVDD or QLAVDD and the data voltages Vd to the data lines D1-Dm.

The gate driver 400 receives the gate control signal CONT1 from the signal controller 600 and generates gate signals including a gate-on voltage Von and a gate-off voltage Voff. The gate driver 400 sequentially applies the gate-on voltage Von to the gate lines G1-Gn to thus turn on the switching elements connected to the gate lines G1-Gn. The data voltages Vd applied to the data lines D1-Dm are applied to their corresponding pixels through the turned-on switching elements.

The voltage difference between the data voltage applied to the pixel PX and the common voltage Vcom may be a pixel voltage of the pixel PX. The luminance of an image may be varied depending on the pixel voltage.

The above-described procedure is repeatedly and sequentially performed on each gate line and each data line for each horizontal period (1H), and thus, the gate-on voltage Von is sequentially applied to all of the gate lines G1-Gn and the data voltages are applied to all of the pixels, therefore displaying a frame of image. When a frame finishes and then a next frame starts, the inverse signal RVS applied to the data driver 500 may be controlled, and thus, the polarity of the data voltage may be opposite to the polarity of the data voltage in the previous frame (“frame inversion”).

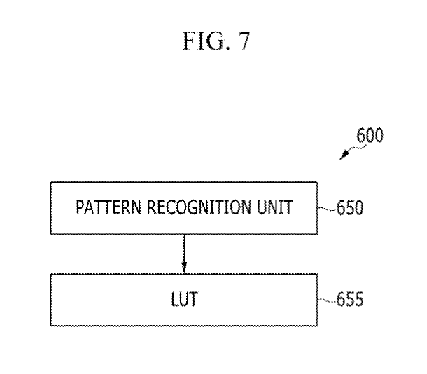

FIG. 7 is a block diagram illustrating a signal controller of a display device according to an exemplary embodiment of the present invention.

Referring to FIGS. 1 and 7, a signal controller 600 according to an exemplary embodiment of the present invention may include a pattern recognition unit 650 and a lookup table (LUT) unit 655.

The pattern recognition unit 650 may determine an image pattern that is included in an image of a frame, based on the input image signal IDAT. For example, the pattern recognition unit 650 may determine a ratio of a black or white grayscale region to the rest in the image. The black grayscale may mean a grayscale smaller than or equal to a predetermined low grayscale, and the white grayscale may mean a grayscale greater than or equal to a predetermined high grayscale. The predetermined low grayscale and the predetermined high grayscale may be substantially the same or different from each other.

The LUT unit 655 stores information about levels of a plurality of quarter power voltages QHAVDD and QLAVDD according to the determined image pattern. For example, as the ratio of the white grayscale region to the rest in the image increases, the level of the high quarter power voltage QHAVDD may increase and the level of the low quarter power voltage QLAVDD may decrease in the LUT unit 655. As the ratio of the black grayscale region to the rest in the image decreases, the level of the high quarter power voltage QHAVDD may decrease and the level of the low quarter power voltage QLAVDD may increase in the LUT unit 655.

The signal controller 600 may generate a driving voltage control signal CONT3 based on the selected information about the levels of the quarter power voltages QHAVDD and QLAVDD of the LUT unit 655.

Alternatively, the LUT unit 655 may be included in the pattern recognition unit 650, or the signal controller 600 and the pattern recognition unit 650 may be separately prepared.

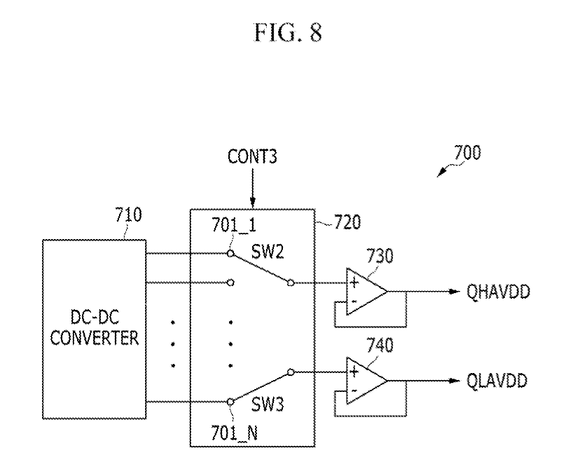

FIG. 8 is a circuit diagram illustrating a driving voltage generator of a display device according to an exemplary embodiment of the present invention.

Referring FIG. 8, the driving voltage generator 700 according to an exemplary embodiment of the present invention may include a DC-DC converter 710, a switching unit 720, and a pair of amplifiers 730 and 740.

The DC-DC converter 710 receives an input voltage and generates a plurality of voltages respectively having different levels from each other. The input voltage of the DC-DC converter 710 may be a power voltage AVDD or a half power voltage HAVDD, but exemplary embodiments of the present invention are not limited thereto. The DC-DC converter 710 includes a plurality of output terminals 701_1, . . . , 701_N for outputting a plurality of voltages therethrough.

The switching unit 720 may include a pair of switches SW2 and SW3 that operate under the control of the driving voltage control signal CONT3. The switch SW2 may be connected between the amplifier 730 and the plurality of output terminals 701_1, . . . , 701_N of the DC-DC converter 710, and the switch SW3 may be connected between the amplifier 740 and the plurality of output terminals 701_1, . . . , 701_N of the DC-DC converter 710. The switch SW2 may be connected to an output terminal through which a higher voltage is output than an intermediate voltage among all of the voltages output through the plurality of output terminals 701_1, . . . , 701_N of the DC-DC converter 710, and the switch SW3 may be connected to an output terminal through which a lower voltage is output than the intermediate voltage among all of the voltages output through the plurality of output terminals 701_1, . . . , 701_N of the DC-DC converter 710. The intermediate voltage may be the half power voltage HAVDD.

The amplifier 730 is connected to the switch SW2, and the amplifier 730 amplifies the voltage transmitted through the switch SW2 and outputs the high quarter power voltage QHAVDD. The amplifier 740 is connected to the switch SW3, and the amplifier 740 amplifies the voltage transmitted through the switch SW3 and outputs the low quarter power voltage QHAVDD. The inverse input terminal (−) of the amplifier 730 or 740 may be connected to the output terminal thereof.

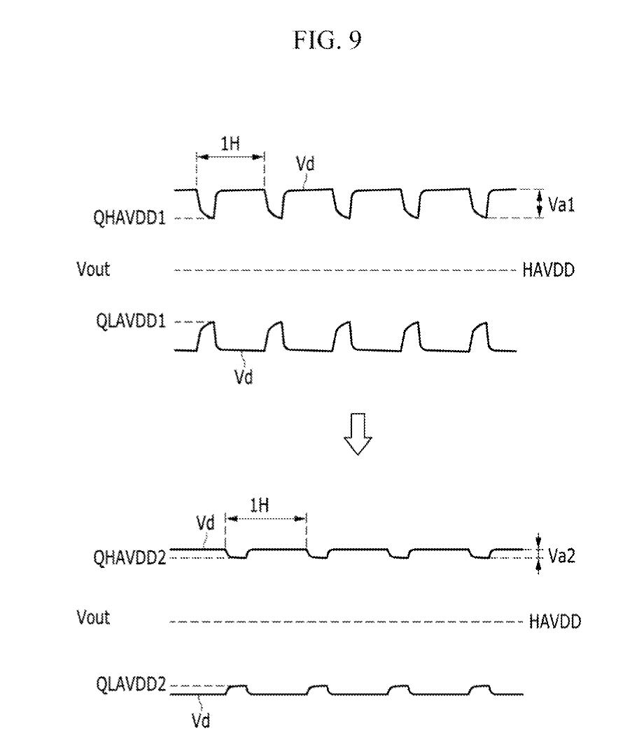

FIG. 9 illustrates waveforms of output voltages from a data driver for several quarter driving voltages.

The quarter power voltages QHAVDD and QLAVDD generated by the driving voltage generator 700 are input to the data driver 500. The data driver 500 may alternately output the quarter power voltages QHAVDD or QLAVDD and the data voltage Vd corresponding to the output image signal DAT.

In an upper part of FIG. 9, when the data voltage Vd corresponds to a high grayscale, a voltage whose magnitude is about ¾ of the magnitude of the power voltage AVDD is output to the data driver 500 as a high quarter power voltage QHAVDD1, and a voltage whose magnitude is about ¼ of the magnitude of the power voltage AVDD is output to the data driver 500 as a low quarter power voltage. As shown in FIG. 9, the upper waveform with respect to the level of the half power voltage HAVDD refers to where the data voltage Vd has a positive polarity, and the lower waveform with respect to the level of the half power voltage HAVDD refers to where the data voltage Vd has a negative polarity. In this case, since the voltage difference (Va1) between the quarter power voltage QHAVDD1 or QLAVDD1 and the data voltage Vd is relatively large, the heat generated from the data driver 500 may be increased by the voltage difference (Va1).

However, referring to a lower part of FIG. 9, when the data voltage Vd corresponds to a high grayscale, the level of the high quarter power voltage QHAVDD2 is increased and the level of the low quarter power voltage QLAVDD2 is decreased, and thus, the voltage difference (Va2) between the data voltage Vd and the quarter power voltage QHAVDD1 or QLAVDD1 is decreased. Therefore, the heat generated from the data driver 500 can be reduced by the decreased voltage difference.

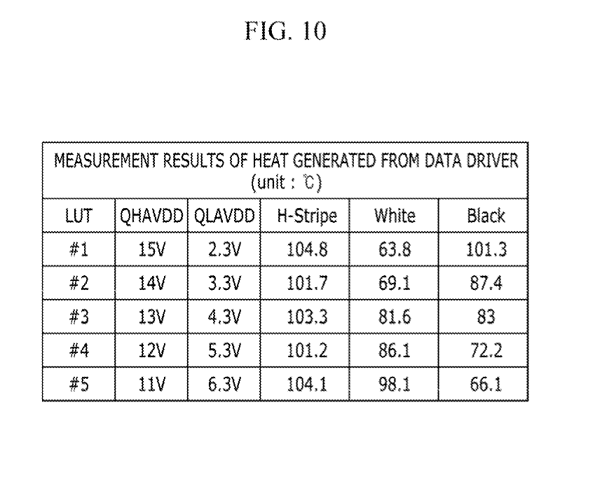

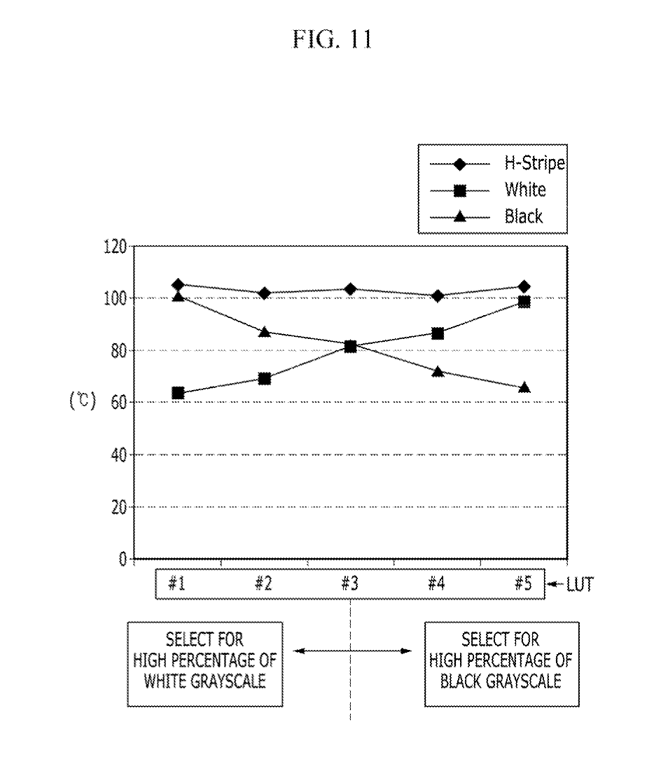

FIG. 10 is a table showing results obtained by measuring the heat generated from a data driver according to quarter driving voltages and image patterns, and FIG. 11 is a graph showing the heat generated for different image patterns according to a lookup table of a pattern recognition unit according to an exemplary embodiment of the present invention.

Referring to FIGS. 10 and 11, when an image mostly expresses a white grayscale, as the high quarter power voltage QHAVDD increases and the low quarter power voltage QLAVDD decreases, the heat generated from the data driver 500 decreases. For example, when an image mostly expresses a high grayscale, the data voltage Vd is close to the power voltage AVDD when the data voltage Vd has a positive polarity, and the data voltage Vd is close to the ground voltage when the data voltage Vd has a negative polarity. Therefore, during the first period (P1), as the high quarter power voltage QHAVDD increases and the low quarter power voltage QLAVDD decreases, the power consumption of the data driver 500 may be decreased, and thus the heat generated from the data driver 500 may be reduced.

Alternatively, when an image expresses a black grayscale, as the high quarter power voltage QHAVDD decreases and the low quarter power voltage QLAVDD increases, the heat generated from the data driver 500 decreases. For example, when an image expresses a low grayscale, the data voltage Vd is close to the half power voltage HAVDD when the data voltage Vd has a positive polarity, and the data voltage Vd is close to the half power voltage HAVDD when the data voltage Vd has a negative polarity. Therefore, during the first period (P1), as the high quarter power voltage QHAVDD decreases and the low quarter power voltage QLAVDD increases, the power consumption of the data driver 500 may be reduced, and thus, the heat generated from the data driver 500 may be decreased.

When an image includes a horizontal stripe pattern, the white grayscale and the black grayscale each occupies about a half of the image area, and the data voltage Vd swings between the black grayscale and the white grayscale for every horizontal period. Therefore, the heat generated from the data driver 500 does not largely depend on the levels of the quarter power voltages QHAVDD and QLAVDD.

The numbers and values of the quarter power voltages QHAVDD and QLAVDD, which are shown in FIGS. 10 and 11, are merely examples and thus may be varied.

The signal controller 600 may have five LUTs when, for example, five levels of quarter power voltages QHAVDD or QLAVDD are stored in the LUTs, as shown in FIGS. 10 and 11.

As shown in FIG. 11, as the region expressing a white grayscale in the pattern of an image increases, an LUT in which the high quarter power voltage QHAVDD is relatively higher and the low quarter power voltage QLAVDD is relatively lower may be selected, controlling the driving voltage generator 700. Since the generated quarter power voltages QHAVDD and QLAVDD are close to the data voltage Vd, the heat generated from the data driver 500 can be reduced. Similarly, as the region expressing a black grayscale in the pattern of an image increases, an LUT in which the high quarter power voltage QHAVDD is relatively lower and the low quarter power voltage QLAVDD is relatively higher may be selected, controlling the driving voltage generator 700. Since the generated quarter power voltages QHAVDD and QLAVDD are close to the data voltage Vd, the heat generated from the data driver 500 can be reduced.

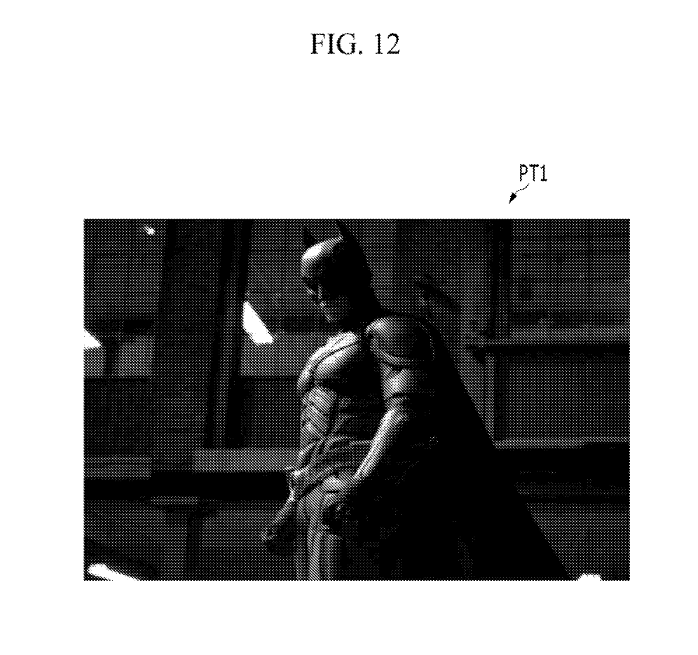

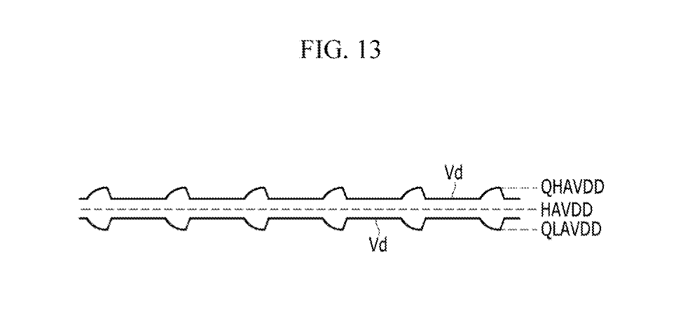

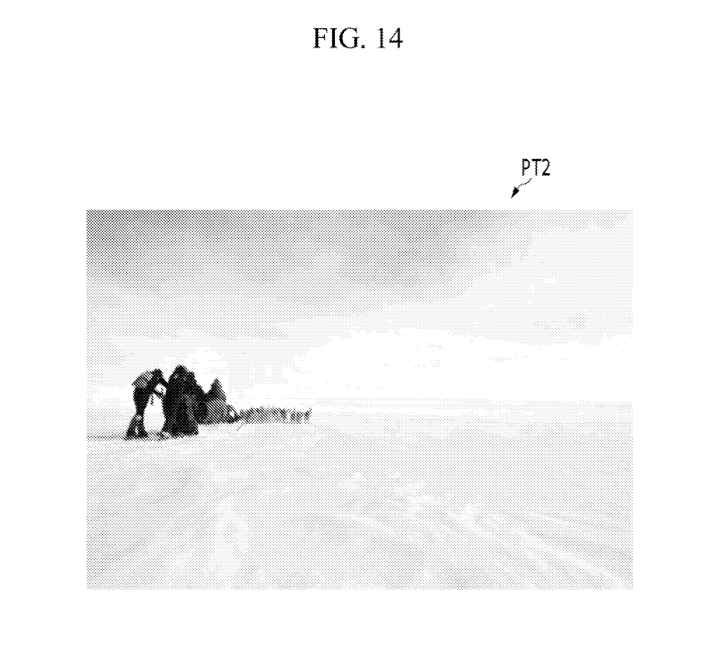

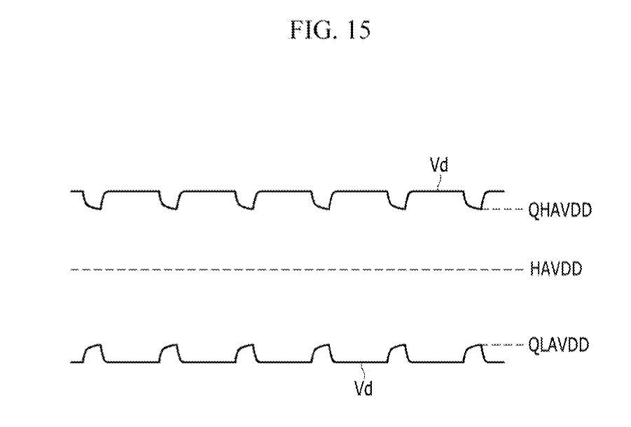

FIG. 12 shows an example image pattern displayed by a display device according to an exemplary embodiment of the present invention. FIG. 13 illustrates waveforms of output voltages output from a data driver for an image pattern as shown in FIG. 12, according to an exemplary embodiment of the present invention. FIG. 14 shows an image pattern displayed by a display device according to an exemplary embodiment of the present invention. FIG. 15 illustrates waveforms of output voltages output from a data driver for an image pattern as shown in FIG. 14, according to an exemplary embodiment of the present invention.

Referring to FIG. 12, a pattern (PT1) of the image shown has mainly black grayscales. Therefore, as shown in FIG. 13, the voltage differences between a low-grayscale data voltage Vd and the quarter power voltage QHAVDD or QLAVDD can be reduced by setting the quarter power voltages QHAVDD and QLAVDD to be close to the half power voltage HAVDD. Therefore, the heat generated from the data driver 500 can be reduced.

Referring to FIG. 14, a pattern (PT2) of the image shown has mainly white grayscales. Therefore, as shown in FIG. 15, the voltage differences between a high-grayscale data voltage Vd and the quarter power voltage QHAVDD or QLAVDD can be reduced by setting the quarter power voltages QHAVDD and QLAVDD to be close to the power voltage AVDD or the ground voltage. Therefore, the heat generated from the data driver 500 can be reduced.

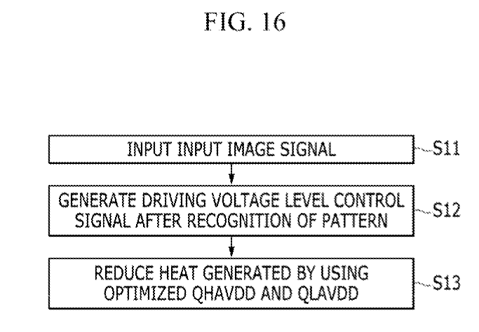

FIG. 16 is a flowchart showing a method of driving a display device according to an exemplary embodiment of the present invention.

Referring to FIG. 16, the signal controller 600 of the display device according to an exemplary embodiment of the present invention receives an input image signal IDAT from, e.g., an external graphics controller (S11).

The signal controller 600 recognizes a pattern of an image based on the input image signal IDAT, determines ratio of a black or white grayscale region to the rest in the image, and generates a driving voltage control signal CONT3 that controls the levels of quarter power voltages QHAVDD and QLAVDD (S12).

The driving voltage generator 700 generates the quarter power voltages QHAVDD and QLAVDD according to the determined results of the pattern of the image under the control of the driving voltage control signal CONT3, and outputs the quarter power voltages QHAVDD and QLAVDD to the data driver 500. The data driver 500 outputs the quarter power voltages QHAVDD and QLAVDD during a first period (P1) before outputting the data voltage Vd corresponding to the input image signal IDAT, and outputs the data voltage Vd during a second period (P2). Therefore, the heat generated from the data driver 500 can be reduced (S13).

While this invention has been shown and described in connection with exemplary embodiments thereof, it is to be understood by those of ordinary skill in the art that various changes in form and detail may be made thereto without departing from the spirit and scope of the invention as defined by the following claims.

What is claimed is:

1. A display device, comprising:
a display panel including a data line;
a driving voltage generator configured to generate a first quarter power voltage (QHAVDD) and a second quarter power voltage (QLAVDD), the first quarter power voltage having a level between a power voltage (AVDD) and a half power voltage (HAVDD), the second quarter power voltage having a level between the half power voltage (HAVDD) and a ground voltage;
a data driver configured to alternately output the first quarter power voltage or the second quarter power voltage and a data voltage to the data line; and
a signal controller configured to control the driving voltage generator and the data driver, wherein the signal controller includes a pattern recognition unit configured to determine an image pattern of an image based on an input image signal, and wherein the signal controller is configured to control the driving voltage generator to adjust the levels of the first quarter power voltage and the second quarter power voltage, based on the determined image pattern.

2. The display device of claim 1, wherein the pattern recognition unit is configured to determine a region that represents, in the image, a grayscale greater than or equal to a predetermined grayscale or smaller than or equal to the predetermined grayscale based on the input image signal.

3. The display device of claim 2, wherein the signal controller further includes a lookup table, the lookup table storing information on a plurality of levels of the first quarter power voltage and a plurality of levels of the second quarter power voltage depending on the region in the image.

4. The display device of claim 3, wherein as the region that represents the grayscale greater than or equal to the predetermined grayscale in the image, the first quarter power voltage in the lookup table increases, and the second quarter power voltage in the lookup table decreases.

5. The display device of claim 3, wherein the data driver includes a switch configured to switch between the data voltage and the first quarter power voltage or the second quarter power voltage.

6. The display device of claim 5, wherein the data driver is configured to output the first quarter power voltage or the second quarter power voltage during a first period and to output the data voltage during a second period following the first period.

7. The display device of claim 6, wherein a sum of the first period and the second period is substantially the same as one horizontal period.

8. The display device of claim 7, wherein the data driver is configured to output the first quarter power voltage during the first period when a polarity of the data voltage is positive and to output the second quarter power voltage during the first period when the polarity of the data voltage is negative.

9. The display device of claim 8, wherein the data voltage output to the data line has a same polarity for one frame.

10. The display device of claim 1, wherein the data driver includes a switch configured to switch between the data voltage and the first quarter power voltage or the second quarter power voltage.

11. A method of driving a display device, the method comprising:
determining an image pattern of an image based on an input image signal;
generating a control signal controlling levels of a first quarter power voltage (QHAVDD) and a second quarter power voltage (QLAVDD) based on the determined image pattern, the first quarter power voltage having a level between a power voltage (AVDD) and a half power voltage (HAVDD), the second quarter power voltage having a level between the half power voltage and a ground voltage;
generating the first quarter power voltage and the second quarter power voltage based on the control signal; and
alternately outputting, by a data driver, the first quarter power voltage or the second quarter power voltage and a data voltage to the data line.

12. The method of claim 11, further comprising determining a region that, in the image, represents a grayscale greater than or equal to a predetermined grayscale or smaller than or equal to the predetermined grayscale.

13. The method of claim 12, wherein the control signal is generated using a lookup table storing information on a plurality of levels of the first quarter power voltage and a plurality of levels of the second quarter power voltage depending on the region in the image.

14. The method of claim 13, wherein as the region that represents the grayscale greater than or equal to the predetermined grayscale in the image, the first quarter power voltage in the lookup table increases, and the second quarter power voltage in the lookup table decreases.

15. The method of claim 13, wherein the data driver includes a switch configured to switch between the data voltage and the first quarter power voltage or the second quarter power voltage.

16. The method of claim 15, wherein the data driver is configured to output the first quarter power voltage or the second quarter power voltage during a first period and to output the data voltage during a second period following the first period.

17. The method of claim 16, wherein a sum of the first period and the second period is substantially the same as one horizontal period.

18. The method of claim 17, wherein the data driver is configured to output the first quarter power voltage during the first period when a polarity of the data voltage is positive and to output the second quarter power voltage during the first period when the polarity of the data voltage is negative.

19. The method of claim 18, wherein the data voltage output to the data line has a same polarity for one frame.

20. The method of claim 11, wherein the data driver includes a switch configured to switch between the data voltage and the first quarter power voltage or the second quarter power voltage.

21. A display device, comprising:
a display panel;
a driving voltage generator configured to generate a power voltage, a half power voltage, a first quarter power voltage, and a second quarter power voltage, the first quarter power voltage having a level between the power voltage and the half power voltage, the second quarter power voltage having a level between the half power voltage and a ground voltage;
a gray voltage generator configured to generate a data voltage from the power voltage and the half power voltage;
a data driver configured to alternately output the first quarter power voltage or the second quarter power voltage and the data voltage to the display panel; and
a signal controller configured to determine an image pattern of an image from an external circuit and configured to control the driving voltage generator to adjust the levels of the first quarter power voltage and the second quarter power voltage, depending on the determined image pattern.
